(19) United States
(12) Patent Application Publication
(10) Pub. No.: US 2026/0195649 A1
(43) Pub. Date: Jul. 9, 2026

(54) SYSTEMS AND COMPUTING DEVICES HAVING ARTIFICIAL INTELLIGENCE (AI) AGENTS TRAINED VIA USER INTERFACES AND CONFIGURED TO MANAGE COMPUTING DEVICE PROCESSES AND RELATED METHODS

(71) Applicant: Bentley J. Olive, Apex, NC (US)

(72) Inventor: Bentley J. Olive, Apex, NC (US)

(21) Appl. No.: 19/438,593

(22) Filed: Jan. 1, 2026

Related U.S. Application Data
(60) Provisional application No. 63/743,436, filed on Jan. 9, 2025.

(51) Int. Cl. G06N 20/00; G06F 3/04842

(52) U.S. Cl. CPC G06N 20/00; G06F 3/04842

(57) ABSTRACT

Systems and computing devices having Artificial Intelligence (AI) agents trained via a user interface and configured to manage computing device processes and related methods are disclosed. According to an aspect, a computing device includes an AI manager configured to train an AI agent for implementing actions in a process. The AI manager is also configured to determine perception of one or more objects or data within an environment. Further, the AI manager determines a confidence metric for a first action for interacting with the objects or data within the environment based on a data model associated with the process, and/or for implementing a second action based on the data model associated with the process. The AI manager presents the confidence indicator or confidence metric for implementing the first action and/or the second action, and trains the artificial intelligence agent to implement the first action and/or the second action.

### CROSS-REFERENCE TO RELATED APPLICATIONS

This application claims priority to U.S. Provisional Application No. 63/743,436, filed Jan. 9, 2025, and titled SYSTEMS AND COMPUTING DEVICES HAVING ARTIFICIAL INTELLIGENCE (AI) AGENTS TRAINED VIA USER INTERFACES AND CONFIGURED TO MANAGE COMPUTING DEVICE PROCESSES AND RELATED METHODS, the disclosure of which is incorporated herein by reference in its entirety.

This application is related to U.S. Pat. No. 10,412,153, issued Sep. 10, 2019; U.S. Pat. No. 10,965,735, issued Mar. 30, 2021; U.S. Pat. No. 11,416,572, issued Aug. 16, 2022; U.S. Pat. No. 11,418,576, issued Aug. 16, 2022; and U.S. Pat. No. 12,216,723, issued Feb. 4, 2025; the disclosures of which are incorporated herein by reference in their entireties.

### BACKGROUND

Artificial intelligence (also referred to as “AI”) is generally a branch of computer science focused on creating systems and technologies that can perform tasks such as learning, reasoning, problem-solving, perception, language understanding, and decision-making. Subsets of AI include, but are not limited to, machine learning (ML), natural language processing (NLP), computer vision, and robotics. AI is designed to replicate or simulate human intelligence to enhance efficiency, solve complex problems, and automate processes.

Various data can be acquired and used for improving AI functionalities. For example, Large Language Models (LLMs) are a particular application of AI designed to understand, generate, and interact with human language. These models can be trained on vast amounts of text data and leverage advanced machine learning techniques to process and generate human-like text.

ML is a subset of AI that enables systems to learn and make predictions or decisions without explicit programming. Instead of being programmed with specific instructions, ML algorithms are trained on data to recognize patterns and improve their performance over time.

AI technologies have significantly improved efficiencies and reduced costs involved in performing various tasks. Although, there is a continuing need to improve the functionalities of AI technologies and enable people to work together with AI to reduce their workload and improve their efficiencies with completing tasks.

### SUMMARY OF THE DISCLOSURE

The presently disclosed subject matter relates to systems and computing devices having AI agents trained via a user interface and configured to manage computing device processes and related methods. According to an aspect, a computing device includes an AI manager configured to train an artificial intelligence agent for implementing actions in a process. The AI manager is also configured to determine perception of one or more objects or data within an environment. Further, the AI manager is configured to use AI to determine a confidence metric for a first action for interacting with the one or more objects or data within the environment based on a data model associated with the process, and/or for implementing a second action based on the data model associated with the process. The AI manager is also configured to present, via a user interface, the confidence indicator or confidence metric for implementing the first action and/or the second action. Further, the AI manager is configured to receive, via the user interface, user input that indicates whether to implement the first action and/or the second action in response to perception of the one or more objects or data within the environment during the process. The AI manager is also configured to train the artificial intelligence agent to implement the first action and/or the second action based on the user input.

According to another aspect, a system includes a first computing device comprising an AI agent manager configured to receive contextual information that indicates a need of a first user. The AI agent manager is also configured to process the contextual information for generative AI response to the contextual information for providing one or more solutions to the need of the first user. A result of the process is generation of an indication of confidence in the one or more solutions. The AI manager is also configured to determine a second user associated with a qualification to provide a solution to the need of the first user. Further, the AI agent manager is configured to communicate to a second computing device associated with the second user some of the information so that the second user can provide a solution.

According to another aspect, a computing device includes an AI agent manager configured to receive contextual information of a first user's operation of a computing device. The AI agent manager is also configured to determine a confidence level for sending a request including the contextual information to a second user based on the contextual information. Further, the AI agent manager is configured to receive a next action based on a received response to the request.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block diagram of a system including a computing device that implements an AI agent manager in accordance with embodiments of the present disclosure;

FIG. 2 is a flow diagram of an example method for implementing an AI agent trained via a user interface in accordance with embodiments of the present disclosure;

FIG. 3 is a flow diagram of an example method for implementing an AI agent trained via a user interface in accordance with embodiments of the present disclosure;

FIG. 4 illustrates a flow diagram of an example method for implementing an AI agent trained via a user interface in accordance with embodiments of the present disclosure;

FIG. 5 is a screen display of an example use of a word processing application being assisted by an AI agent in accordance with embodiments of the present disclosure;

FIG. 6 is a screen display of an example use of an email application being assisted by an AI agent in accordance with embodiments of the present disclosure;

FIG. 7 is a screen display showing an example of an image generated by AI along with confidence metrics indicated in area for the image in accordance with embodiments of the present disclosure;

FIG. 8 is a screen display showing an example of photo that has been captured and edited by AI along with confidence metrics indicated in area for editing of the photo in accordance with embodiments of the present disclosure;

FIG. 9 are screen displays showing an example of summarizing and providing information in response to receipt of a text with confidence metrics indicated in area in accordance with embodiments of the present disclosure;

FIG. 10 are screen displays showing an example of an email being drafted or composed with confidence metrics indicated in area in accordance with embodiments of the present disclosure; and

FIG. 11 is a screen display showing an example of an AI agent summarizing selected text with confidence metrics indicated in area in accordance with embodiments of the present disclosure.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As referred to herein, the term “generative artificial intelligence” (or “generative AI”) refers to an area of artificial intelligence models that can create new content. For example, generative AI models can learn patterns and structures from existing data and use that knowledge to create new data that is similar in nature. Further, generative AI can involve variational autoencoders (VAEs), which are models that learn to encode input data into a lower-dimensional space and then decode it back to the original space, allowing them to generate new data points by sampling from the latent space. Generative AI can also involve generative adversarial networks (GANs), which can include two neural networks, a generator and a discriminator, that are trained simultaneously. The generator creates new data, and the discriminator evaluates its authenticity, leading to the generation of increasingly realistic data.

As referred to herein, the terms “artificial intelligence agent” or “AI agent” refers to a computing function or functions designed to perceive its environment, make decisions, and take actions to partially or wholly complete one or more tasks. The computing function(s) can be implemented by one or more computing devices (e.g., via its hardware, software, firmware, or combinations thereof). The environment can be a real world environment (e.g., real world environment in which a robot is working to complete a task; e.g., a computing environment within which a user operates, such as a user using a user interface to perform tasks on a computing device, such as a task on a computing application). AI agents can operate autonomously or semi-autonomously, interact with their surroundings, and can continuously adapt their behavior based on feedback or learning. AI agents can range from simple programs to complex entities capable of advanced reasoning and learning.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

In embodiments, a computing device that is portable by a person may be used to entirely or partially implement AI agents and/or to partially manage processes and methods as disclosed herein. For example, portable computing devices may include, but are not limited to, smartphones, tablet computers, laptops, and wearable devices (e.g., smartwatches or smartglasses). Data utilized for these functions may be entirely or at least partially stored within the portable computing device.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

In embodiments, computing devices and systems are described herein as perceiving one or more objects or data within an environment. As an example, an object perceptible within an environment may be a display object on a display screen of a computing device. In another example, data within an environment may be text, graphically-presented data (e.g., a bar graph) on a display screen of a computing device. In another example, an object perceptible within an environment may be an object that exists in space and time, making them perceptible via human senses (sight, touch, etc.) in contrast to abstract objects (e.g, a concept), which are not perceivable).

In embodiments, systems and computing devices disclosed herein can have functionalities for detecting, determining, or otherwise receiving data of objects or data that are perceptible by a human. In an example, a computing device can use a camera to capture images of objects and data displayed on another display of another computing device or objects within a real world environment. As an example, screen readers with optical character recognition (OCR) tools can capture the visible portion of the screen (including inaccessible UI or images of text) and run OCR so content can be interpreted. In another example, real-time camera-based OCR applications can use the camera to continuously capture what is displayed on a display or printed page and perform real-time OCR for interpretation.

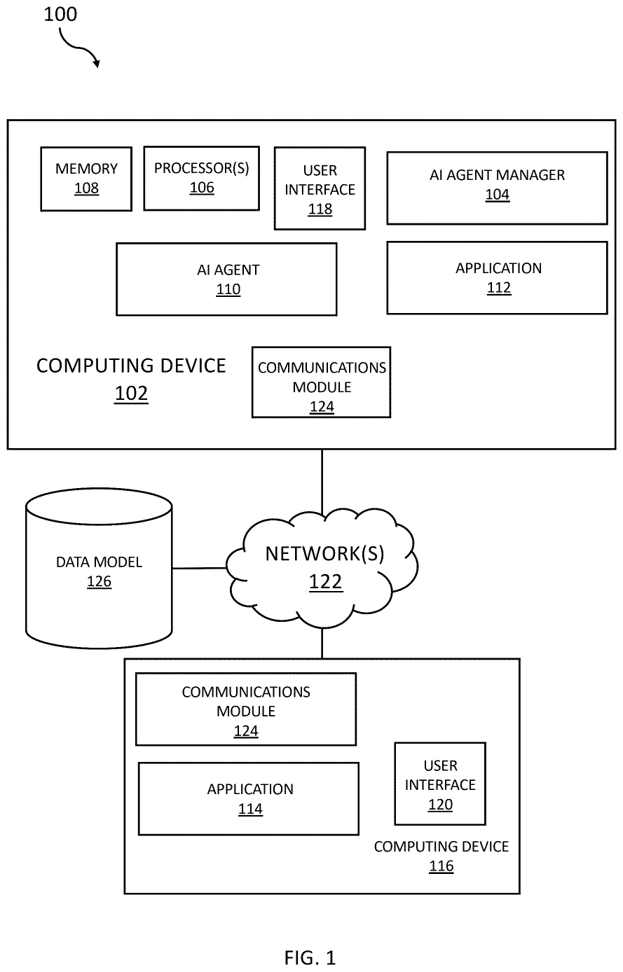

FIG. 1 illustrates a block diagram of a system 100 including a computing device 102 that implements an AI agent manager 104 in accordance with embodiments of the present disclosure. Referring to FIG. 1, functionalities of the AI manager 104 described herein can be implemented by hardware, software, firmware, or combinations thereof. For example, the AI manager 104 may be implemented by one or more processors 106 implementing instructions residing within memory 108.

The AI agent manager 104 can be configured to train an AI agent 110 for implementing actions in a process or operation. For example, a process may include one or more actions implemented by a computing device or other machine to perform a task. In an example, a process action can include an action that can be implemented by a human via a user interface and/or an AI agent performing one or more actions in place of the human. For example, an application 112 may reside on the computing device 102, or an application 114 may reside on another remote computing device 116. In an example, an application can be a word processing application, a spreadsheet application, an email application, a web browser application, or the like. During operation, the application may present (e.g., display via a display of the computing device) one or more display objects (e.g., buttons that may be clicked to implement an action, a dropdown menu for selection among several items, a text box for entry of text, or the like) that can be interacted with via a user display (e.g., a user interface 118 of computing device 102 or a user interface 120 of computing device 116). In this example, display objects may be interacted with or controlled by the AI agent to perform an action in a process to complete a task. Example tasks include, but are not limited to, composing an email (e.g., an original email or reply email to another email), creating or modifying a spreadsheet, conducting a search to retrieve information or data via a web browser, or the like.

The AI agent 110 can input commands for controlling the application 112 to implement an action. For example, the AI agent 110 can input a command to interact with a display object presented by the application 112. Further, for example, the AI agent 110 can also control the application 114 to implement an action at remote computing device 116 by communication of a command via one or more networks (e.g., Internet and/or cellular network) 122 or directly via direct wireless communication (e.g., BLUETOOTH™ wireless communication). Computing devices 102 and 116 can each include communications modules 124 configured for communication via the network(s) 122 or via direct wireless communication.

The AI agent manager 104 can train the AI agent for implementing actions in a process. For example, the AI agent manager 104 can access a data model 126 that has been trained on data used or generated by use of the same or similar application as being used for implementing the process. For example, the data model 126 may contain data trained on data of actions taken by others on the same or similar applications on which the AI agent 110 is operating. For example, the AI agent 110 may be implementing actions in a process on a word processing application or email application, and the data of the data model 126 may have been trained based on actions taken in the same or similar process of the same or similar word processing application or email application.

In an example, the data model can indicate one or more actions to implement in response to perception of one or more objects within a process implemented by an application. For example, during implementation of an email application, a reply email can be initiated in the email application and can be suggested in response to presentation (e.g., display of an incoming email in the email application).

The data model 126 may be suitably stored in a memory accessible via the network(s) 122. For example, the data model 126 may be stored within a web server or other suitable computing device that can be accessed by the computing device 102.

In an example, a confidence level or metric may be determined based on a probability assigned to a possible result, outcome, step to be take in a process, or determination. For example, AI utilized by the subject matter disclosed herein such as the AI agent manager 104 can calculate a confidence score or metric based on probabilities assigned to different possible results, outcomes, steps to be take in a process, or determinations during a prediction process. This can be implemented via a function, which translates raw output into a probability distribution where higher probabilities indicate greater confidence in a result, outcome, step to be take in a process or determination. This indicates how likely the AI believes its prediction is to be correct based on the data it has been trained on. AI models can use a softmax function to normalize the output values into probabilities that sum to 1, making it easier to interpret the confidence level. A higher probability associated with a particular answer indicates greater confidence from the AI model. To ensure that the confidence scores accurately reflect the true probability of correctness, AI models can undergo a process called “calibration” to adjust the confidence levels based on validation data.

The AI agent manager 104 can determine perception of one or more objects or data within an environment. For example, the AI agent manager 104 can perceive or determine the presentation of one or more objects or data within an environment, such as a process of a person's workflow. In the example of a person's workflow, a worker may be entering data of one document into a spreadsheet. The AI agent manager 104 (e.g., residing on computing device 102 or computing device 116) can determine that a spreadsheet application is opened on the computing device 116. Further, the AI agent manager 104 can recognize another application is opened and that data is presented by the other application (e.g., an email is open with data in it, or a word processing document is open with data in it). The AI agent manager 104 can also recognize various identification data of the other opened application (e.g., sender of an email, subject line of an email, subject of a body of an email, title of a word processing document, or the like). The AI agent manager 104 can also determine labels of columns and/or rows of an opened spreadsheet. In this example and in a process to train an AI agent, the AI agent manager 104 can consider these perceived objects and data for training the AI agents for possible next steps in a process.

The AI agent manager 104 can use artificial intelligence to determine a confidence metric for a first action for interacting with the one or more objects or data within the environment based on a data model associated with the process, and/or for implementing a second action based on the data model associated with the process. Continuing the aforementioned example, the AI agent manager 104 can determine a confidence metric for a first action and/or subsequent actions for interacting with the objects or data in the presented environment based on a data model. For example, the AI agent manager 104 can use a model to determine that a next step may be that data is to be entered into the spreadsheet, data is to be read from the spreadsheet, and/or an action is to be implemented on the spreadsheet.

The AI agent manager 104 can present, via a user interface, the confidence indicator or confidence metric for implementing the first action and/or the second action.

The AI agent manager 104 can receive, via the user interface, user input that indicates whether to implement the first action and/or the second action in response to perception of the one or more objects or data within the environment during the process.

The AI agent manager 104 can train the artificial intelligence agent to implement the first action and/or the second action based on the user input.

Advantageously, for example, the presently disclosed subject matter can enable users to better automate processes via an AI agent for their particular tasks. For example, an AI agent manager can provide a user with a suggested action in a process along with a confidence indicator or confidence metric. The user can subsequently select whether or not for the AI agent to implement the suggested action when the same or similar process is subsequently being implemented. Although applications can be previously programmed to suggest or automatically implement actions, the presently disclosed subject matter can leverage data of data models, the user's previous actions, and other users' actions along with AI applications (e.g., generative AI being applied to such data) to such data for suggesting actions for the user's specific processes for the user's specific tasks.

In accordance with embodiments, an AI agent as disclosed herein can operate on any suitable computing device, and the computing device can direct or communicate commands to another computing device implementing a process. For example, a smartphone can use its camera to capture images of an environment such as a display screen. In this example, the display screen can display one or more objects (e.g., buttons, text boxes, dropdown menus, etc. that can be interacted with to implement the process). An AI agent residing on the smartphone or associated with the smartphone can perceive the one or more objects in accordance with embodiments. Subsequently, the AI agent can use artificial intelligence to determine a confidence metric for a first action for interacting with the one or more objects or data within the environment based on a data model associated with the process, and/or for implementing a second action based on the data model associated with the process. Further, the AI agent can present, via a user interface (e.g. a display) of the smartphone, the confidence indicator or confidence metric for implementing the first action and/or the second action. Further, the smartphone can receive, via the user interface of the smartphone (e.g., a touchscreen display of the smartphone), user input that indicates whether to implement the first action and/or the second action in response to perception of the one or more objects or data within the environment during the process. Further, the smartphone's AI manager can train the artificial intelligence agent to implement the first action and/or the second action based on the user input. It is also noted that the AI agent can reside on the computing device implementing the process. In this case, the AI agent can perceive the presentation of the one or more objects and can provide suitable commands for interacting with the one or more objects.

In an example scenario in accordance with embodiments, example steps can include one or more of:
(1) Store a person's context information;
(2) Receive/determine person's reaction/response to stimuli (e.g., comments, music selection, etc.);
(3) Use this in (2) to present to another with similar/same context (this is similar to feedback of a person's personality);
Example, post on social media or other text (then can get the AI person's reaction/response to something similar); and
Limit AI to a reliable data set as a “security”.

In an example scenario, a visual way can be to provide for assigning a work task to an AI agent. In an example, one or more steps can include:
(1) Email arrives;
(2) On display, the user moves it to an area for AI agent to begin analysis and propose one or more actions to take;
(3) AI agent can review context of user's current state (e.g., upcoming meeting to determine actions);
(4) then user can select one of the options;
(5) AI agent can then begin working on it (drafting email, etc.); and
(6) User can be prompted to review, edit, approve the work done by AI

In some examples, the user can interact with the user interface (e.g., display objects) for changing an AI emulation of a person; for example, for certain interfaces with the actual user or another person you may want the AI to emulate a business-like tone; in another example you may want it to emulate a casual, friendly tone; also the response can emulate some identified person (e.g. celebrity).

The user interface can be used to switch between the different AI emulators.

In another example, the user interface can present more of the “behind the scenes” of what the AI is doing. For example, it can control the source of content that the generative AI is using, etc.

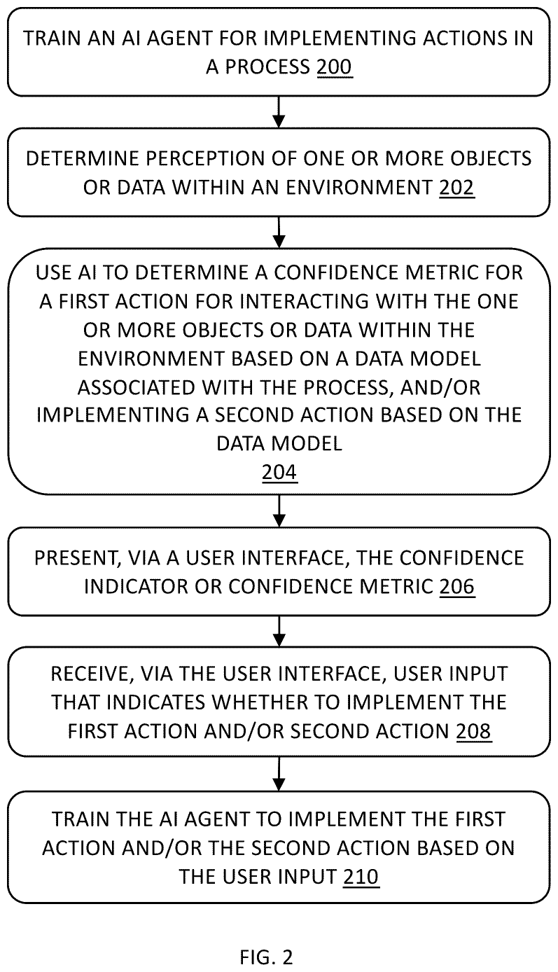

FIG. 2 illustrates a flow diagram of an example method for implementing an AI agent trained via a user interface in accordance with embodiments of the present disclosure. The method is described as being implemented by the system 100 shown in FIG. 1, but it should be understood that the method may be implemented by any suitable system.

Referring to FIG. 2, the method includes training 200 an artificial intelligence agent for implementing actions in a process. As an example, the AI agent manager 104 shown in FIG. 1 can train the AI agent 110 for implementing actions in a process. During a process, the application may present (e.g., display via a display of the computing device) one or more display objects (e.g., buttons that may be clicked to implement an action, a dropdown menu for selection among several items, a text box for entry of text, or the like) that can be interacted with via a user display (e.g., a user interface 118 of computing device 102 or a user interface 120 of computing device 116). In this example, display objects may be interacted with or controlled by the AI agent to perform an action in a process to complete a task. The AI agent manager 104 can access the data model 126 that has been trained on data used or generated by use of the same or similar application as being used for implementing the process. For example, the data model 126 may contain data trained on data of actions taken by others on the same or similar applications on which the AI agent 110 is operating. For example, the AI agent 110 may be implementing actions in a process on a word processing application or email application, and the data of the data model 126 may have been trained based on actions taken in the same or similar process of the same or similar word processing application or email application. The data model can indicate one or more actions to implement in response to perception of one or more objects within a process implemented by an application. For example, during implementation of an email application, a reply email can be initiated in the email application and can be suggested in response to presentation (e.g., display of an incoming email in the email application).

The method of FIG. 2 includes determining 202 perception of one or more objects or data within an environment. Continuing the aforementioned example, objects within the environment may be a display object on a display screen of a computing device. In another example, data within an environment may be text, graphically-presented data (e.g., a bar graph) on a display screen of a computing device. In another example, an object perceptible within an environment may be an object that exists in space and time, making them perceptible via human senses (sight, touch, etc.) in contrast to abstract objects (e.g, a concept), which are not perceivable). The computing device 116 may include one or more cameras or other equipment configured to perceive the object and suitably stored data indicative of the object. Further for example, the AI agent manager 104 can perceive or determine the presentation of one or more objects or data within an environment, such as a process of a person's workflow. In the example of a person's workflow, a worker may be entering data of one document into a spreadsheet. The AI agent manager 104 (e.g., residing on computing device 102 or computing device 116) can determine that a spreadsheet application is opened on the computing device 116. Further, the AI agent manager 104 can recognize another application is opened and that data is presented by the other application (e.g., an email is open with data in it, or a word processing document is open with data in it). The AI agent manager 104 can also recognize various identification data of the other opened application (e.g., sender of an email, subject line of an email, subject of a body of an email, title of a word processing document, or the like). The AI agent manager 104 can also determine labels of columns and/or rows of an opened spreadsheet. In this example and in a process to train an AI agent, the AI agent manager 104 can consider these perceived objects and data for training the AI agents for possible next steps in a process.

The method of FIG. 2 includes using 204 AI to determine a confidence metric for a first action for interacting with the one or more objects or data within the environment based on a data model associated with the process, and/or for implementing a second action based on the data model associated with the process. Continuing the aforementioned example, the AI agent manager 104 can use artificial intelligence to determine a confidence metric for a first action for interacting with the one or more objects or data within the environment based on a data model associated with the process, and/or for implementing a second action based on the data model associated with the process. For example, the AI agent manager 104 can determine a confidence metric for a first action and/or subsequent actions for interacting with the objects or data in the presented environment based on a data model. For example, the AI agent manager 104 can use a model to determine that a next step may be that data is to be entered into the spreadsheet, data is to be read from the spreadsheet, and/or an action is to be implemented on the spreadsheet.

The method of FIG. 2 includes presenting 206, via a user interface, the confidence indicator or confidence metric for implementing the first action and/or the second action. Continuing the aforementioned example, the AI agent manager 104 can present, via a user interface, the confidence indicator or confidence metric for implementing the first action and/or the second action.

The method of FIG. 2 includes receiving 208, via the user interface, user input that indicates whether to implement the first action and/or the second action in response to perception of the one or more objects or data within the environment during the process. Continuing the aforementioned example, the AI agent manager 104 can receive, via the user interface, user input that indicates whether to implement the first action and/or the second action in response to perception of the one or more objects or data within the environment during the process.

The method of FIG. 2 includes training 210 the AI agent to implement the first action and/or the second action based on the user input. Continuing the aforementioned example, the AI agent manager 104 can implement the first action and/or the second action based on the user input.

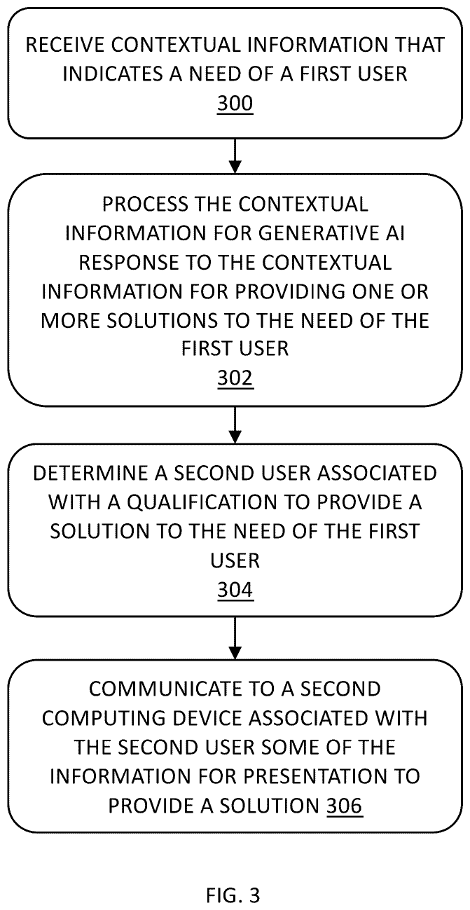

FIG. 3 illustrates a flow diagram of an example method for implementing an AI agent trained via a user interface in accordance with embodiments of the present disclosure. The method is described as being implemented by the system 100 shown in FIG. 1, but it should be understood that the method may be implemented by any suitable system.

Referring to FIG. 3, the method includes receiving 300 contextual information that indicates a need of a first user. For example, the computing device 116 can store contextual information. In this example, the computing device 116 may be running a spreadsheet application. The spreadsheet may contain financial information including a balance sheet, an income statement, and a cash flow statement for a company. In addition, the computing device 116 may receive an email about an upcoming meeting for discussing the finances of a company. Alternatively, a calendar entry may indicate the upcoming meeting and that a topic for the meeting is to discuss the finances of the company. This data may be contextual information that indicates a need of the first user and that is suitable stored within the computing device. Particularly for example, this data indicates financial information for the company and that there is an upcoming meeting to discuss the finances of the company. It can be inferred that financial information in the spreadsheet and analysis of this financial information may likely be discussed at the scheduled meeting. Further, the communication module 124 of the computing device 116 may communicate this data to the computing device 102, where the AI agent manager 104 of the computing device 102 receives the contextual information that indicates the need of the user of the computing device 116.

The method of FIG. 3 includes processing 302 the contextual information for generative AI response to the contextual information for providing one or more solutions to the need of the first user, wherein a result of the process is generation of an indication of confidence in the one or more solutions. Continuing the aforementioned example, the AI agent manager 104 can process the received contextual information for generative AI response to the contextual information for providing one or more solutions to the need of the user of the computing device 116. In an example, the financial information can be analyzed to generate more insightful information, such as profitability, liquidity, solvency, efficiency, growth, and the like. Other example analyses include, but are not limited to, horizontal analysis, vertical analysis, ratio analysis, DuPoint analysis, cash flow analysis, and the like. Further for example, the AI agent manager 104 can generate the analysis data for presentation to the user of the computing device 116, such as graphical representations of the data (e.g., graphs) or text of the data. In another example, the AI agent manager 104 may add additional pages to the spreadsheet that includes the analysis data (including formulas for generating the analysis data). The user of the computing device 116 may proactively forward the generated analysis data to another for review prior to the scheduled meeting.

The method of FIG. 3 includes determining 304 a second user associated with a qualification to provide a solution to the need of the first user. Continuing the aforementioned example, the AI agent manager 104 can utilize the contextual data for determining another user with a qualification to provide a solution to the need of the user of the computing device 116. For example, the AI agent manager 104 may consider some or all of the users in the same organization (e.g., company of employment) as the user of the computing device 102. These users within the organization may each be associated with a credit level or ranking that reflects that user's timeliness, correctness, quality rating from prior requesters, responsiveness, and/or the like in relation to a subject of the contextual information. In this example, subject may be the finances of the company or another specific aspect of the company identified or determined by the contextual information. For example, the determined other user may be a person in the company's accounting department or human resources department with a credit level above a particular threshold. Examples of determining and routing queries/requests to experts in a subject can be in U.S. Pat. No. 10,412,153, the disclosure of which is incorporated herein by reference in its entirety.

The method of FIG. 3 includes communicating 306 to a second computing device associated with the second user some of the information for presentation to provide a solution. Continuing the aforementioned example, the AI agent manager 104 can use the communications module 124 to send some or all of the contextual information to a computing device of the expert or knowledgeable person in the company. The expert or knowledgeable person can be presented the contextual information at her or his computing device. The expert or knowledgeable person can then enter information that may be useful based on the contextual information and send it in a reply to the computing device 102 for forwarding to the computing device 116, or send it directly to the computing device 116. The user at the computing device 116 may subsequently be presented with the entered information and use it for the scheduled meeting.

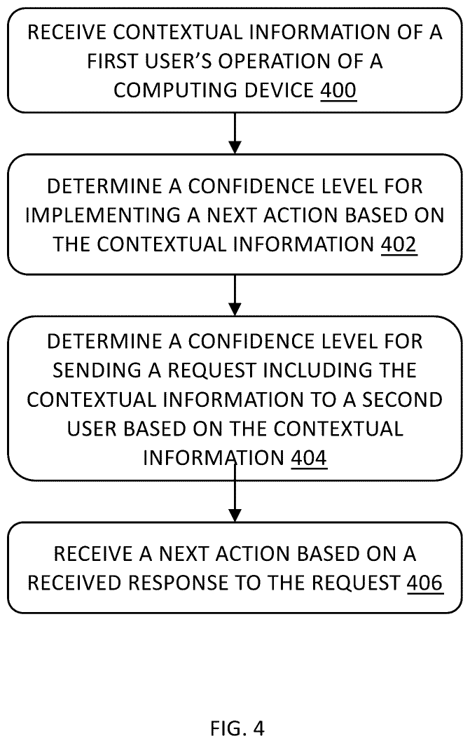

FIG. 4 illustrates a flow diagram of an example method for implementing an AI agent trained via a user interface in accordance with embodiments of the present disclosure. The method is described as being implemented by the system 100 shown in FIG. 1, but it should be understood that the method may be implemented by any suitable system.

Referring to FIG. 4, the method includes receiving 400 contextual information of a first user's operation of a computing device. For example, the user of the computing device 116 may be using a presentation application (e.g., Microsoft's PowerPoint application) to create a slideshow for presentation at an upcoming business meeting. Information input into the slides and the slideshow may be communication to the computing device 102 for processing by the AI agent manager 104.

The method of FIG. 4 includes determining 402 a confidence level for implementing a next action based on the contextual information. Continuing the aforementioned example, the AI agent manager 104 can determine a confidence level for implementing a next action for creating the slideshow based on the contextual information. For example, the slideshow may be a presentation of financial information for a company. The slideshow may already have entered basic financial information (e.g., a balance sheet) of the company. As an example, the AI agent manager 104 may determine a confidence level of adding a slide with analysis information based on a balance sheet included in the slideshow. For example, the additional slide may be growth projections based on the balance sheet. Further for example, the AI agent manager 104 may receive information indicating any other context such as, but not limited to, user interface state and data workflow for determining a confidence level (or confidence score) for candidate actions, and automate or propose actions based on thresholds.

The method of FIG. 4 includes determining 404 a confidence level for sending a request including the contextual information to a second user based on the contextual information. The request can include a request for a next recommended action based on the contextual information. Continuing the aforementioned example, the AI agent manager 104 can determine a confidence level for sending the contextual information to a second user based on the contextual information. For example, the AI agent manager 104 can route the contextual information to other users (or candidate responders) based on their credit levels in a subject (e.g., finances of the company). The credit level of a user can depend on response quality and timeliness with regard to the subject. The user receiving the contextual information can review it and provide a suggested next action or data for use by the user of the computing device 116 for creating the slideshow. This suggested next action or data can be sent to the computing device 102. The computing device 102 can forward the suggested next action or data to the computing device 116 for use in generating the slideshow.

In embodiments, an AI agent can monitor confidence metrics or other uncertainty indicators while managing a process. For example, the process can include, but is not limited to, editing a document, handling a transaction, or configuring a system. In response to determining that confidence falls below a threshold or a policy indicates human oversight is required for this type of step, the AI agent manager 104 can package the current context (task description, relevant data, category, etc.) into a request and sends the request to a deemed expert in a subject relating to the context. For example, the AI agent manager 104 can analyze the context, matches it to categories (e.g., “computer technology,” “finance,” “food services”), and selects candidate responders based on credit level, ranking, availability, location, or other criteria. Communication paths to candidate responders can be dynamically generated to high-credit experts; weights/pathways strengthen or weaken as experts provide timely, high-quality answers, so the AI agent manger 104 receives responses preferentially from those with proven performance in that subject. Expert responses (which may follow templates, multiple-choice fields, or free text) can be received by the AI agent manger 104 and parsed into structured options such as “approve request,” “request more documentation,” “apply fix X,” or “escalate to service Y.”

The method of FIG. 4 includes receiving 406 a next action based on a received response to the request. Continuing the aforementioned example, the response indicating a suggested next action for creating the slideshow can be received at the computing device 116. The user of the computing device 116 can view the suggested next action. For example, the suggested next action can include information (e.g., additional financial analysis information) that may be included on an additional slide of the slideshow. The user of the computing device 116 may subsequently interact with the computing device 116 for adding the suggested slide to the slideshow. In addition, a communication pathway may be automatically opened for communication between the users to exchange additional communications about the slideshow. For example, the user of the computing device 116 may have additional questions.

In an example in accordance with embodiment, the AI can provide tips/suggestions on responding to another based on the other person's communications to them. The suggested responses can be tailored just to that specific person. So the actual user can be given suggestions for text, etc. to include in an email or other communication based on this. This can be graphically presented to the user. The motivation for the AI to provide this different suggestion for that person can be presented to the user so they know why that came about. It is basically a source for why it came up with that. This presentation of the reasoning the AI comes up with what it does can be presented to the user either graphically or otherwise. That way the user can add/subtract certain of these factors to see how that affects a response suggestion.

In embodiments, the AI agent can find a gap in knowledge and subsequently search for a real person to provide an answer or verification of an answer or conclusion. So it can search for the best candidates to provide the answer or verification. For example, in response to determining a confidence metric as being low in a predetermined condition, the AI agent can determine one or more subject matter experts to communicate to. This determination may be based on a condition of the environment, a subject, and/or a level of expert of one or more users.

In embodiments, an AI agent residing on one device (e.g. smartphone) can send signals via a wireless connection (e.g. Bluetooth) to control another device. The device with AI agent can take a picture or video of another device and then control input to the other device via the wireless connection. Further, the device with AI agent can display on its own display an interface of the other device and make suggestions for the user of the AI device to input instructions into the other device. For example, the AI agent device can make recognize an application being run and then explain how to use it to the user, and provide suggestions for input.

In embodiments, a person (e.g., a seller) can train an AI agent to perform certain tasks. The services of this AI agent can be sold on a work network application, etc. to someone needing help. They could be automatically connected via an application. For example, the work network application can be a “gig” work network application.

In embodiments, when given a user interface to interact with, the user may engage an AI agent to fully or partially assist with the interaction. For example, the user interface may display an application's interface on the user interface. The user may then open and interact with an AI agent for assisting with interacting with the application. Upon opening the AI agent, the user can select from several settings for the interaction. A dropdown menu or the like may be presented so that the user may select a setting. In one example, the user may select a profile that the user established or another user established for interacting with the application. For example, the user or another user may have set up some preferences for interacting with the application based on a context of running the application (e.g. time of day, location). Also, a key setting may be for the user to select one or more databases for use by the AI agent when interfacing with the application. In an example, the user may have a word processing application opened, and the AI agent may write or provide suggestions for the word processing document based on content of the user's previous word processing documents or a database of papers (e.g. scientific articles) to help with the writing). In another example, the user may have a music application opened and the AI can create a playlist based on another's playlist. In another example, an email application can be opened, and the AI can suggest wording for an email based on context such as who the email is being sent to, wording the user has entered into the subject, or body of the email. In one example, the context and data from which the AI can base its action can be open windows or applications other than the one in which the AI is to take action (so this data of the other windows or applications can be more heavily weighted than other context or data).

In embodiments, confidence metrics can be based on a vector. For example, generative AI may be utilized for determining actions and confidence metrics associated with the action. Vectors with respect to generative AI are representations of data, enabling it to process, analyze, and generate complex outputs such as text, images, or audio. For example with text, words, phrases, and sentences are converted into numerical representations called word embeddings. Models like Word2Vec, GloVe, or embeddings from transformers (e.g., BERT, GPT) map words into high-dimensional vector spaces. Similar words have vectors that are close to each other in this space. With images, images can be transformed into vectors using convolutional neural networks (CNNs) or other feature extractors. Each vector encodes information about color, texture, and spatial arrangement. With audio, sounds can be converted into spectrograms or other representations and then encoded into vectors capturing features like pitch and frequency. Generative AI uses these vectors to learn patterns, relationships, and distributions in the data. Example processes can include latent space and attention mechanisms. Generative models like GANs (Generative Adversarial Networks) and VAEs (Variational Autoencoders) operate in a latent space, where input data is compressed into vectors. In models like transformers, vectors are used to compute relationships between different data points, enabling context-aware generation. In text generation, the model decides which parts of the input text are most relevant to predicting the next word. AI agents can perceive their environment (input data) through sensors (e.g., APIs, user interactions, data streams). Further, AI agents can create, predict, or enhance outputs. An AI agent can operate in an environment, or otherwise known as a context within which it operates, such as a virtual environment, real-world system, or online platform. An AI agent can have a state representation, or an internal understanding of the environment, often encoded as a vector or other structured data. A model can be, for example, GPT, DALL-E, or StyleGAN, or another that the agent uses to create or generate content. An AI agent can utilize decision-making logic or algorithms (e.g., reinforcement learning, planning systems) that guide the agent's actions based on its goals and the environment. Example AI agents are content creation agents, interactive agents, autonomous agents, and collaborative agents. Content creation agents use AI models to create outputs such as text, images, videos, music, or other multimedia. Interactive agents use AI models to engage with humans or other systems, such as chatbots, virtual assistants, and game playing agents. Autonomous agents can operate with limits human intervention and can adapt dynamically, such as research assistants, and simulation agents generating virtual environments or testing scenarios. Collaborative agents can work alongside humans to enhance creativity or productivity, such as co-writing tools or design partners.

In embodiments, the question may be: How to trust the output of an AI agent? To do this, have certain data verified by a human. Example—require that a human scroll through the information to verify they have reviewed it (may use eye tracking). Then the user can be rated based on their experience and prior review. The user can provide their own along with verified other data (the other data may be rated).

In embodiments, a person can create a large language model (LLM) that is personalized for use by others or that person. That person can get paid for it by subscription, etc. it can be used to control musical and other entertainment selections. It can skip to key parts of movies, articles, etc.

In embodiments, a user can build their own LLM from which the AI agent can work. In an example, the LLM can be provided with emails, texts, and other communications of the user. In another example, the user can actively add parts of articles and other materials that the user may have read. The AI agent utilizing this content may be limited in that it analyzes and extracts only factual information. Then this factual information can be used as part of the user-created LLM. In another example, video and pictures captured by the user can be included in the LLM. In this example, it can include data recognized in images, etc. In embodiments, an AI agent may be used to conduct search for information (for example it can interact with a news source and search with a search engine to fine information each day and build an LLM for use by the user). The user can train it what and how to search. Subsequently, it can summarize the findings.

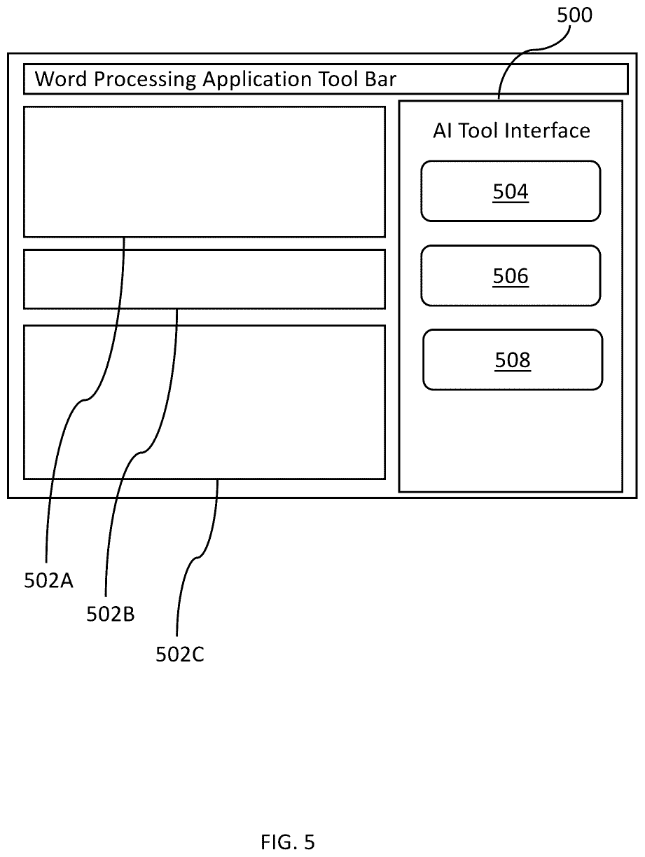

FIG. 5 illustrates a screen display of an example use of a word processing application being assisted by an AI agent in accordance with embodiments of the present disclosure. Referring to FIG. 5, a word processing application may be running. Reference 500 indicates a dropdown menu that can be an interface for the AI agent. The menu 500 includes buttons 504, 506, 508 for the user to select to allow the AI to use different things for assisting with the use of the word processing application. For example, button 504 can provide the AI with access to other word processing documents authored by the user or others. Subsequently, the AI can provide suggestions based on these other word processing documents. Button 506 can be a database of works such as scientific articles, or other references. References 502A, 502B, 502C are portions (e.g. paragraphs of the word processing document that the user has entered. The user can use the interface to select one or more of the portions 502A, 502B, 502C to apply the AI agent to. A button 510 can be used to select a different user for influence on the AI (for example, the other user's profile, writings can be used for making suggestions/changes to the text or a selected part of the text. Also, changes made by the AI can be indicated by a track changes feature with an indication of the influence on the change and citations.

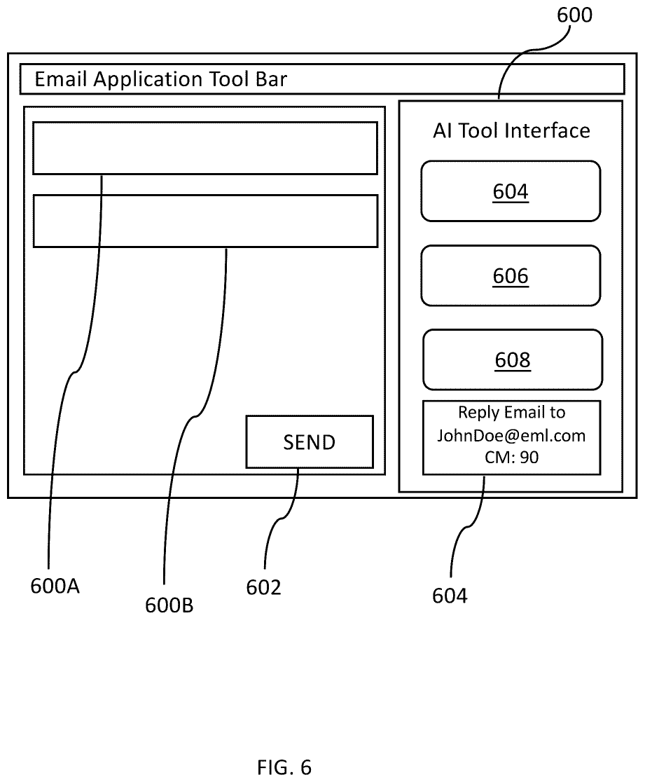

In an example scenario according to embodiments, an email application is running on a computing device. For example, FIG. 6 illustrates a screen display of an example use of an email application being assisted by an AI agent in accordance with embodiments of the present disclosure. The interface of the email application can be opened and displayed (e.g., various objects such as emails 600A, 600B, send buttons 602, receive buttons, identification of recipients and senders, etc.). The AI agent can assist with email replies. In one example, the AI agent can be trained by the user to handle emails in the Inbox. For example, the AI agent can be trained to store and/or reply to emails. An email can be received in a 1^{st} training iteration by asking or suggesting that the user (1) start a reply to the email; and (2) store the email in a folder of the email application or a folder of a file storage application. In this initial step, the AI agent can suggest one or both of the 2 based on observations previously made by the user and/or other users. The AI agent can also present a confidence metric level of selecting these choices. For example, the AI agent can control the display of an indicator area 604 that indicates a confidence metric (e.g., number) for a step of drafting a reply email to an email received by a particular email address. In this example, a confidence metric of 90 is indicated for drafting a reply email to JohnDoe@eml.com upon receipt of the email. Further, in this example, the AI agent may generate a high confidence metric such as 90 in response to the user being observed as frequently replying to email from that email address. Subsequently, the user may train the AI agent to accept the recommendation of drafting the reply email and always draft a reply email in response to it (further the reply email may include a greeting to a person named in a Contacts list having the email address and also draft language for responding to the text contained in the body of the email. If there is a request for information, the AI agent may search in predetermined files for such information and extract the information to place in the email, or also attached the relevant file to the email automatically. The user can subsequently review the email, make any edits, and send the reply email). In a training mode for a particular process flow, the user can then respond by indicating whether to do one or both for all emails; by indicating whether to do one or both for emails from this particular domain (e.g., “@businessname.com”) or particular sender (also a confidence metric for such actions can be indicated by display or otherwise). The AI agent can also be instructed to either prompt before implementing these steps, or ask for each step and give a confidence level indication (one could be 100% confidence if the user previously indicated to perform exactly those steps). Based on just this, the AI agent can be trained to handle emails from a particular domain or sender. Then subsequently the AI agent can either automatically implement the steps or ask authorization for each step before proceeding.

In another example of training, the AI agent can read the email and perform a task such as fetching and attaching a document that is referred to in the email. For example, the AI agent can search titles or content of files based on information in the email. Then the AI agent can suggest attaching these and/or suggest citing language in such files when responding to the email. Further, such content can be summarized and presented for entry into the email. In training for implementing such a step, the user may specify folders to search for a particular email sender or domain for that email in the Inbox. This can improve efficiency because the user does not actively need to conduct the search and also the reply email will be more thorough with the reply to perhaps avoid further emails on the subject of the email.

In embodiments of training, confidence metrics associated with proposed actions in a process may be presented (e.g., displayed) to a user and used for training. The user may want to be asked for each step in the process about whether to proceed. For each step, the AI agent may indicate which step it suggests to take next along with the following (1) Whether the user previously indicated to take the step (that would be 100% confidence but need verification); (2) a suggested step based on the AI agent's observation; (3) if there is a discrepancy in user instructions, the AI can indicate multiple options along with confidence levels. The AI can also ask if the user wants to verify the step so that the user is not asked again in future implementations of the process. In that case, the AI agent would just automatically proceed with the step without asking. The data could be just the user's or it can also include other users. Some of the other users could be those within the same organization, so a user can specify which other user to pull data from.

In embodiments, augmented reality (AR) glasses or a smartphone with AR may present options along with confidence metrics overlayed on a display presenting the application. In this case, the AR device can send control signals to the computing device with the application to proceed with the process. It may communicate with suitable wireless communications technology, such as BLUETOOTH™.

In embodiments, a subject matter expert can train AI agents for others' processes. This training can provide steps and corresponding confidence metrics in a step-by-step process. This person can be an “expert” identified in a particular subject, and this person can create AI agents that can be retrieved by others based on an “expertise level” of the creator. Confidence metrics presented for different steps can be higher if it was a step suggested by an expert.

In accordance with other embodiments, the present disclosure can implement a checklist feature generated by an AI agent based on what it recognizes in the flow from the user or others (others may have generated checklists). The checklist can appear at different steps in the process, and the user can enter their own checklist. Some steps can be prevented from proceeding unless certain steps were confirmed by the user as being completed. In an example, wording, such as “critical” or “important”, or other indicators can trigger the AI to generate a checklist to confirm that the user has either completed that task or read the language associated with the wording.

In embodiments, automatic tasks can also be included that include administrative tasks such as saving a document or file after certain steps (not just periodically such as every 10 minutes).

In embodiments, an AI agent can use machine vision to recognize what's needed that is being displayed (e.g., buttons, text boxes, and other display objects that may need interaction).

In embodiments, an AI agent can use the second device (i.e., the computing device that is implementing the AI and controlling the other computing device) for easier entry of information or interaction with display objects (e.g., a text box may be presented on the second device that corresponds to a text box of the 1^{st} device so that the user may enter the information there.

In embodiments, an AI agent can proceed with a step if the confidence level is above a predetermined threshold. For example, when playing music the confidence level can be low when a step is associated with which song to play or what to organize in a playlist. In another example, the confidence level can be set high for a business process because error avoidance is really important.

In embodiments, an AI agent can deduce a next step in a process based on the user's previous inputs and/or others' previous inputs in similar situations.

In embodiments, a process can include steps of navigating, interpreting and extracting data from one or more documents (e.g., spreadsheets, word processing documents with tables, etc.). Subsequently, this information can be used to populate an email, report, or other document as a step in a process.

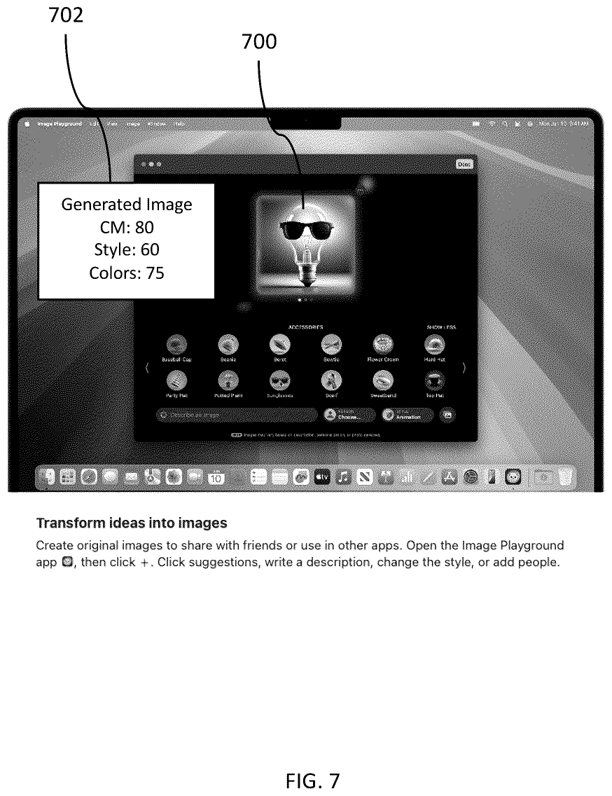

FIG. 7 illustrates a screen display showing an example of an image 700 generated by AI along with confidence metrics indicated in area 702 for the image in accordance with embodiments of the present disclosure. For example, the choice of image 700 displayed to the user can include (1) an indication of a confidence level of use of the choice, and (2) an indication of a source of the choice (such as another user whose LLM is being used, and/or images saved by the user); and (3) user's choices in a similar situation. In the area 702, a general confidence metric of 80 is indicated. Also, choices of style and colors are indicated as 60 and 75, respectively. The user may subsequently interact with the area 702 by selecting it to enter whether or not the choice is approved or selection of another choice. For example, the user may approve the use of sunglasses in image 700, but not the use of a lightbulb. Further, the user may approve the color of the sunglasses. Therefore, the selection of approval or non-approval may be used by the AI agent for later image generations.

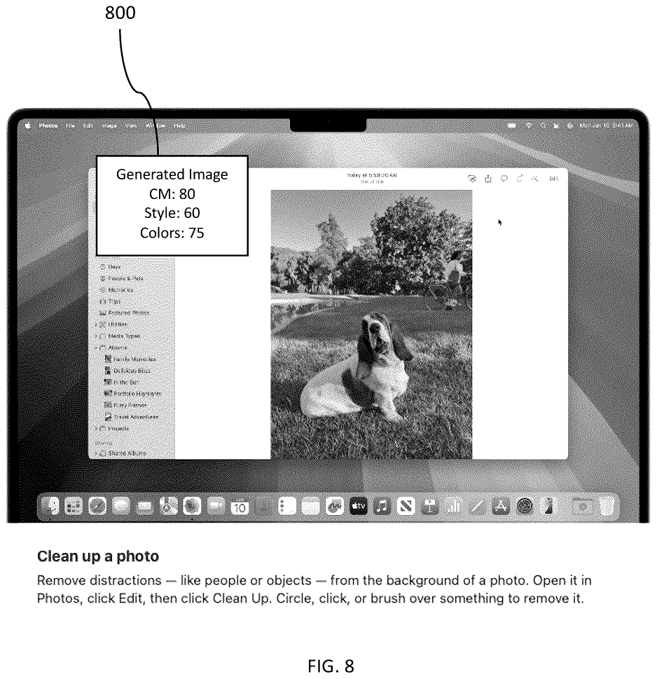

FIG. 8 illustrates a screen display showing an example of photo that has been captured and edited by AI along with confidence metrics indicated in area 800 for editing of the photo in accordance with embodiments of the present disclosure. For example, people or other objects in the photo may be suggested to be removed. A confidence metric with such editing may be presented. Subsequently, the user may interact with the area 800 to approve or disapprove of such editing. Subsequently, in other image captures, the AI agent may control such approved editing and indicate confidence metrics with other suggested editing to improve a work flow process. Other edits may include any suitable type of editing such as contrast, coloring, brightness control, or the like. Further, other suggested actions may include suggesting to text or email the photo to a person recognized in the photo along with a confidence metric for doing so. A draft text or email may automatically be generated by the AI agent upon approval. In embodiments, different versions of the photo with different edits may be presented to the user along with confidence metrics for each. For example, edited photos with the highest confidence metrics may be presented. In this example, the user may select one of the photos for use.

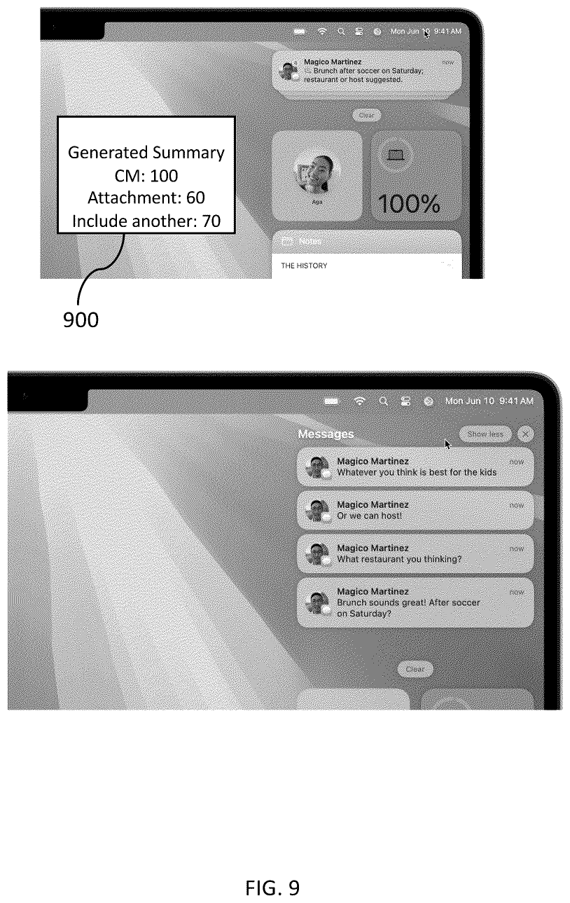

FIG. 9 illustrates screen displays showing an example of summarizing and providing information in response to receipt of a text with confidence metrics indicated in area 900 in accordance with embodiments of the present disclosure. For example, the top screen display in FIG. 9 shows a summary of texts received from a particular sender. The bottom screen display in FIG. 9 shows the actual received texts. Area 900 shows a confidence metric of 100 for summarizing the texts, meaning that the confidence level is high for generating a summary of multiple texts from this person. This may be desired in the instance of another sending a lot of texts within a short amount of time, such that a summary is beneficial. Further, the area 900 indicates a confidence metric 60 for including an attachment in a reply to the text. In this example, the text may request a recently-captured photo, a file, or other information within previous replies (e.g., a time, date or location to meet for coffee or meal). Such attachment may be approved for particular text senders, or disapproved for others. Also, photos with the sender in them may be approved for sending and have a high confidence metric. The AI agent may draft a reply text and the user may select to send the reply text. A confidence metric 70 can be indicated for including another such as a common friend with the text reply.

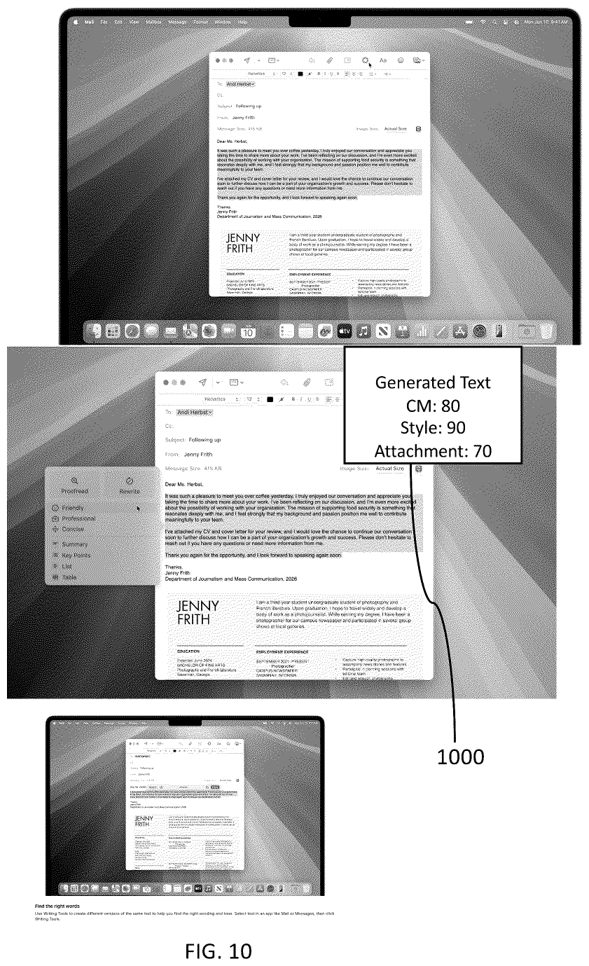

FIG. 10 illustrates screen displays showing an example of an email being drafted or composed with confidence metrics indicated in area 1000 in accordance with embodiments of the present disclosure. For example, the top screen display in FIG. 10 shows an initial draft of an email composed by a user. The middle screen display in FIG. 10 shows suggested changes in a draft generated by an AI agent. With the middle screen display, the AI agent can present area 1000 including a confidence metric 80 for the generated draft in general. Further, the confidence metric 90 for the style can be indicated. For example, the email can be drafted casual for a friend, but can be drafted professional for a business associate. Different versions of style of writing for the email and confidence metrics can be presented. The user may select preference of a style for particular user or domain of an email address. Further, the area 1000 indicates a confidence metric 600 for including an attachment in a reply to the text. In this example, the email may reference a recently-captured photo, a file, or other information within previous replies (e.g., a time, date or location to meet for coffee or meal). Such attachment may be approved for particular text senders, or disapproved for others. Also, photos with the sender in them may be approved for sending and have a high confidence metric. The AI agent may select to send the email and edit the email.

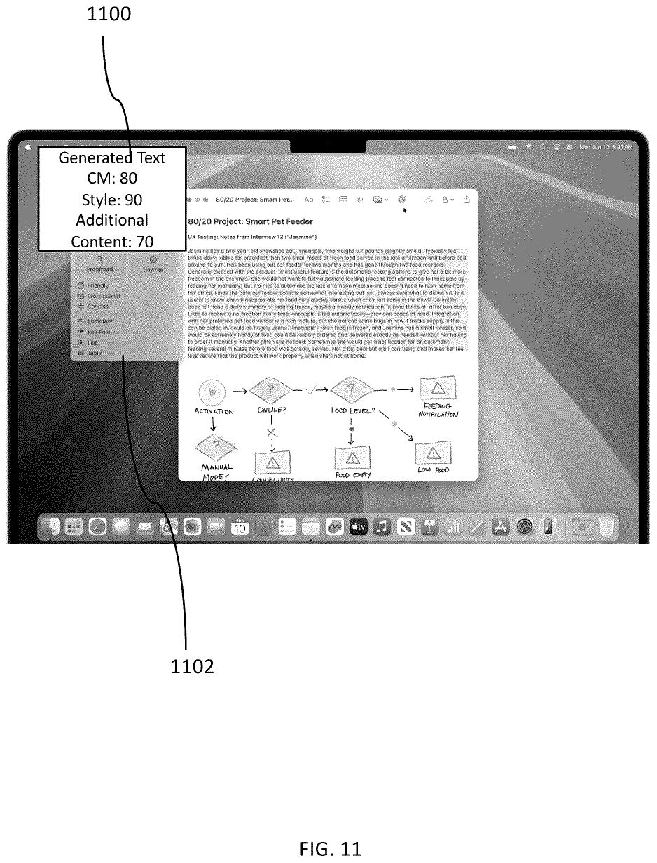

FIG. 11 illustrates a screen display showing an example of an AI agent summarizing selected text with confidence metrics indicated in area 1100 in accordance with embodiments of the present disclosure. For example, a user may enter text. An AI agent can generate a text box 1102 indicating suggested changes, including style change, summarization, and additional content (e.g., flow chart or table based on the entered text). The AI agent can present the area 1100 including a confidence metric 95 for the generated suggested edits/additions in general. Further, confidence metrics for different styles of editing the entered text can be indicated. Different versions of style of writing for the text and confidence metrics can be presented. The user may select preference of a style for particular subject of content (e.g., description of a vacation or notes from a business meeting). Further, the area 1100 indicates a confidence metric 70 for including additional content along with the text (e.g., a list of attendees of a business meeting; graphs or other such depictions of data indicated in a business meeting (such as financials); and photos in the case of a vacation description). The versions generated by the AI agent can be presented to the user for acceptance entirely or acceptance of the different suggested aspects.

In embodiments, information in an audio file can be processed by an AI agent. For example, text, sounds, or other data in an audio file can be recognized and summarized. In response thereto, reply or other content (such as a summary) may be generated and confidence metrics presented related thereto in accordance with embodiments.

In embodiments, an AI agent can be utilized to provide commands and suggested processes or steps for commanding an autonomous or semi-autonomous machine other than a computing device. For example, an AI agent may reside in a smartphone or other computing device configured to control another machine (e.g., a drone, a robotic vacuum cleaner, or functionality of an automobile). For example, the AI agent may control a smartphone to wirelessly communicate a command signal to the machine. The AI agent may be trained on a process for implementation by the machine. For example, in the case of a robotic vacuum cleaner, the process may include cleaning a kitchen area. The robotic vacuum cleaner may be pre-programmed with instructions for cleaning an area, such as turning when encountering an obstacle and/or avoid drop offs. In addition, the robotic vacuum cleaner may add an additional functionality of avoiding a pet or spill area. A smartphone may implement computer vision to recognize a pet or spill area, and the smartphone may be trained to avoid a pet or spill area. Various models for implementing this additional functionality may be generated by the user or acquired by others. The AI agent may also present suggested actions and confidence metrics for avoiding other objects in a similar or same environment. In another example, a drone can be associated with an AI agent to train it using models for performing tasks such as acquiring images or videos of areas such as buildings or natural features (e.g., waterfalls and rivers). A user can confirm suggested actions of the AI agent to confirm the correct steps. In embodiments, a smartphone can have an application that guides the user in finding AI agents that others have generated and also generate their own AI agent.

In embodiments, an AI agent can run isolated from inputs and data except those that are strictly controlled by the use. In this way, the user has more confidence of the output and better security. For example, a user may initiate an agent for a particular task and specify only particular models and/or sources of data for training the agent. In an example, an AI agent may be generated and trained for generating email replies. In this example for email replies, the user may specify that the AI agent can only be trained on models generated by others within an organization, and that data may only be drawn from other related emails or particular files of the organization. In another example, an AI agent may be generated and trained for generating documents (such as business documents, emails, or letters). In this example for email replies, the user may specify that the AI agent can only be trained on models generated by others within an organization, and that data may only be drawn from other related documents or particular files of the organization. In this way, the security of actions implemented or suggested by the AI agent can be limited and more likely secure.

In embodiments, a confidence metric can be generated based on data and a time of generation of the data. For example, a confidence metric can be higher if some content is newer than other. For example, the AI agent can score content in whole or portions of it on the basis of it's newness compared to what the person has already been presented. This helps to filter redundant information. Also, the information can be summarized if the score is high enough, or rather the new part summarized or highlighted.

In embodiment, a user interface manager can be provided for interacting with an AI agent. For example in a windows-based environment, a user can grab an object and move it to another location on a display screen for an AI agent to take the next step of action. For example, an email in an Inbox can be moved over to a window of an AI agent with an area for taking an action on the email such as composing a draft email; and then the draft email can be set as a To Do item for the user to review and send later in accordance with a set process for handling email actions. The AI agent can also have a data set as a “go by” for implementing its task. For example, it can refine the drafted email based on the “go by” data set.

In accordance with embodiments, a system, such as the system shown in FIG. 1, can (1) observe a work habit of a person; (2) correlate the observed work habit to another; and (3) suggest an action or AI prompts for gathering information to help that person with the work. For example, it can be educational for the person or a suggestion to improve their work processes. An example, application is an office environment.

In accordance with embodiments, a system, such as the system shown in FIG. 1, can (1) manage an artificial intelligence agent configured with instructions for implementing a process (e.g., a work task) involving a plurality of computing device applications (e.g., an email manager such as MICROSOFT OUTLOOK®, and an accounting application such as QUICKBOOKS® accounting application); (2) receiving, via a user interface, a request to implement the process; (3) engage the plurality of computing device applications to input the instructions in response to the request; (4) receive, from one of the plurality of computing device applications presentation of a result of input of the instructions and a request for verification to finalize implementation of the process; and (5) receive, via the user interface, approval OR non-approval for final implementation of the process.

In accordance with embodiment, an AI agent manager may maintain a database of stored email exchanges and/or other enterprise information for use in training for a process. This stored data may include information on next steps in a process. The AI agent manager may use this information to suggest a similar next step in a similar or same type of process.

In accordance with embodiments, a system, such as the system shown in FIG. 1, can (1) store actions associated with computing device applications, and results of those actions; (2) receive, via user interface, identification of two or more of the computing device applications; (3) receive, via the user interface, identification of a desired result; and (4) determine and suggest one or more actions for obtaining the desired result. One or more actions can be associated with a credit level or other metric indicating a likelihood of the action(s) achieving a result. The one or more actions with the highest credit level or other metric can be used. Inputs by other users or other data can be used for assigning the credit level.

In accordance with embodiments, an AI agent manager can recognize affinity between applications or other processes implemented by a computing device. For example, the AI agent manager may receive data regarding processes implemented by applications on a computing device, and compare the data to determine a relatedness of affinity between the data of the applications. For example, the AI agent manager may recognize that the data of the applications relates to the same or similar subject. Further, the AI agent manager may recognize that data of one application may be useful or needed for a process being implemented by the other application. The AI agent manager may also recognize that that data of one application may be useful or needed for an action that can be implemented by the other application. In response to this recognition, the AI agent manager may suggest use of the data of one application in the other application via a user interface of the computing device in accordance with embodiments disclosed herein. For example, an incoming email to an email application from a particular source may require or be useful in an action at another application. For example, an incoming email from Account Receivable department of a source may require the action of opening the invoice that is attached to the email and extracting data such as a fee, a description of the fee, a date, and an invoice. This extracted data may be automatically entered into an accounting application (e.g., QuickBooks) for authorization to pay. The individual responsible for paying the client can be notified and application opened for them to authorize payment. Therefore in this case, the email application has an affinity to the accounting application and the data can be used accordingly.

In accordance with embodiments, AI agents as disclosed herein may operate based on datasets of processes using deep learning techniques. This AI system can be trained on these datasets of processes, which may be referred to as a Large Process Model (LPM). LPMs may operate by processing vast amounts of process data to generate suggested actions or perform actions. For example, the action may be an action implemented by a computing device or a user input received by the computing device. AI agents as disclosed herein may be trained by any suitable technique. In an example, an AI agent can receive input in the form of actions of a process (e.g., initiate drafting of an email, inserting data into a spreadsheet, extracting data used by one application and inputting the extracted data into another application). The input can be tokenized (e.g., broken into smaller units sub-actions or data) and converted into numerical representations (embeddings) that the model can process. LPMs can use a transformer architecture, a neural network design that excels at understanding relationships between actions in a process. This allows the model to grasp context, type of action, and meaning. The model can use attention mechanisms to focus on relevant parts of the input when generating a suggested action. The model can predict the next action or token in a process sequence based on patterns learned during training. The model can repeat this process to generate coherent text. For tasks other than suggesting a next action, the model can use learned patterns to tailor its output to the specific goal. Some AI agents are fine-tuned for specific tasks (e.g., service, coding, or analysis), enabling them to follow instructions or perform actions like retrieving data or interacting with external systems. Agents may incorporate tools (e.g., web search, calculators) to augment their capabilities, combining LPM outputs with external data or computations. Advanced agents maintain a “memory” of prior interactions within a session or across sessions, allowing them to provide consistent and context-aware suggested actions. They may also use retrieval-augmented generation (RAG), pulling relevant information from external databases or documents to enhance suggested actions.

In embodiments, training of an LPM as disclosed herein can involve multiple stages. In an example, an LPM can be trained on diverse datasets, including application process data, such as a sequence of actions in a process and data of a process. Data of a process can be received from computing devices implementing processes. As an example, the process data may be retrieved from computing devices of users within an organization. The users may be running the same or similar applications, and the LPM can be trained on processes run on the applications. In embodiments, the application process data can be proactively retrieved when users are interacting with the computing device running the application. In another example, users can select to upload their application data (e.g., actions implemented by the application, and/or an action taken by a user (e.g., user input for taking an action) as described by examples herein). The data can be cleaned and preprocessed to remove noise and ensure quality. Some datasets may include code, dialogues, or action data to enhance versatility. The model learns to predict the next action in a process (causal process modeling) or fill in missing actions (masked action modeling). The model can be fed massive amounts of process data, and its parameters (weights in the neural network) are adjusted to minimize prediction errors. This can be done using gradient-based optimization techniques like backpropagation. Pretraining involves billions of tokens and requires powerful hardware (e.g., GPUs or TPUs) over weeks or months. To adapt the pretrained model for specific tasks or improve its behavior (e.g., making it more helpful or aligned with user expectations). The model can be trained on curated datasets with input-output pairs (e.g., action implemented in a process and actions input by a user) to refine its ability to follow instructions. Human feedback can be used to rank model outputs, and reinforcement learning optimizes the model to prioritize high-quality, safe, and aligned responses. For specialized agents, additional training on data (e.g., process data provided by users exceeding predetermined credit level for a subject matter) tailors the model to particular fields. The model can be tested on benchmarks to assess its performance in areas like reasoning, language understanding, or task completion. Iterative improvements can be made by adjusting training data, fine-tuning strategies, or model architecture based on evaluation results. Once trained, the model can be deployed for real-world use. Systems can incorporate user interactions to further refine performance, though this is carefully managed to avoid introducing biases or errors. Continuous updates may involve retraining with new data or fine-tuning to address emerging needs or correct issues. LPMs can improve with more data and larger model sizes. They can handle a wide range of tasks without explicit programming, due to broad pretraining. In summary, LPM-based AI agents can operate by transforming a current-process state into meaningful suggested actions using patterns learned from extensive training. Their training involves pretraining on vast datasets, fine-tuning for specific tasks, and iterative refinement to align with user needs and ethical standards.

In embodiments, the presently disclosed subject matter can utilize a Virtual Conversation (vCon)-enabled system for training an AI agent for implementing actions in a process. For example, communication exchange between humans can be captured and stored by a vCon-enabled system. The communication exchange can be stored according to vCon standards. The stored communication exchange can be analyzed for determining a process to be implemented by one of the persons involved in the exchange. A system in accordance with the present disclosure can subsequently initiate the process in response to determining that the process is to be implemented by one of the persons. Subsequent steps in the process may be implemented according to examples described herein.

In accordance with embodiments, systems and computer-implemented methods disclosed herein can add another layer to a programming stack for computing devices. Systems and computer-implemented methods disclosed herein can enable a user to utilize a computing device (e.g., wearable computing glasses, smartglasses, or a smartphone) to program actions of another device, which may operate at an application layer level. For example, a person wearing smartglasses can operate at a stack level above a smartphone running one or more applications and being interfaced with by the user at an application layer level. In an example, the smartphone can be operating at the application layer level of the Open Systems Interconnection (OSI) model.

In embodiments, systems and computer-implemented methods disclosed herein can be used by users to publish actions and processes that can be implemented by an application or multiple applications. The person who publishes the actions and/or processes can be rated with credits according to a quality of the publication. Users can access/download the actions/processes for implementation. These processes can be implemented by a computing device that can interface with the computing device where the apps reside. For example, smartglasses can perceive a display having objects, other graphics or information presented for interacting with one or more apps. The smartglasses can control input such as moving a cursor to interact with displayed objects, entering text, etc. The user can also see what is displayed to oversee each step. For sensitive data such as password entry, the process may stop to permit user entry.

In an example, initially one can be a publisher and utilize AI for generating a process that can be utilized for an application or multiple applications for interaction by another user. An example follows: (a) the user can open an application or multiple applications on his/her computing device; (b) the computing device can present objects (e.g. display the objects) for interface; (c) another computing device of the user (e.g. smart glasses or other device capable of interacting with the computing device) can perceive the presented objects; (d) the other computing device of the user can also perceive inputs either by “seeing” or perceiving the inputs on the screen or otherwise for going through steps of the process; (e) the other computing device may utilize AI to analyze the perceived inputs, the perceived presented objects; and potentially others' inputs/presented objects for the same or similar process to generate a set of instructions for implementing the process (also the user may enter marks at points where the user implementing the process must enter secured data such as login and password information or other sensitive data—steps must be taken to ensure the data is protected and/or that a step does not proceed without the user's authorization); (f) the process may be published (like on a search engine) for others' use; (g) others may utilize and provide a review (e.g. number of stars) so that others may know how well this process works; and (h) others may download and utilize the process like other examples provided herein.

In embodiments, systems and computer-implemented methods disclosed herein can include a perception layer for perceiving objects within an environment. For example, the perception layer can include UI hooks that read which applications are open, which buttons or text fields are visible, and what text or images they contain. Further, computer vision modules to recognize on-screen objects if working from screenshots or a camera feed (e.g., smart glasses inspecting another device's display). API integrations for back-end systems (e.g., email server, accounting system, document store) can fetch structured context. Text can be tokenized and converted to embeddings; images and screens are processed by CNN or vision transformers to feature vectors; categorical signals (sender domain, app type, time of day) are encoded as numeric features. The features can be concatenated or otherwise fused into a single state vector representing the current step in the process.

A decision model can include a neural network (e.g., transformer-based model) or other ML model (e.g., gradient-boosted trees) takes the state vector and outputs scores for actions such as “reply,” “file email,” “open invoice in accounting app,” “summarize messages,” or “no-op.”. In some more dynamic processes, a reinforcement-learning agent uses the state to select actions that maximize expected long-term reward (e.g., process efficiency, reduced user workload, lower error rate). The model's raw outputs (logits) can be transformed into probabilities over actions, typically with a softmax function; the top action's probability is treated as the confidence metric. Calibration techniques adjust these probabilities so that a “90%” confidence corresponds more closely to a true 90% success rate on validation data. A configurable policy layer uses the confidence metric plus domain rules to decide: execute automatically, request user confirmation, propose alternatives, or route to a human expert. As an example: auto-draft replies when confidence>0.9 from a known sender; require approval for edits to financial spreadsheets unless confidence>0.99. Policies can be context-aware: stricter thresholds for high-risk actions (payments, data deletions) and looser thresholds for low-risk actions (playlist changes, visual style suggestions). The UI can show suggested actions with confidence indicators (e.g., “Draft reply: 90%,” “Attach related invoice: 60%”) and allows accept/reject or modification. User feedback is logged, and the agent is retrained or fine-tuned so that approval of a suggestion in similar contexts increases future confidence and the likelihood of autonomous execution.

The same logic can be realized across different hardware configurations. A smartphone, AR glasses, or PC runs the AI agent manager on local processors (CPU, GPU, or dedicated NPUs) and stores models and policies in local memory. The device can use its own sensors (e.g., camera, touchscreen, keyboard) to perceive the environment and then issues commands to local or remote applications via OS APIs, Bluetooth, or other wireless protocols. This setup suits privacy-sensitive or latency-critical processes, because all decision-making and confidence computation occur locally. Lightweight perception and pre-processing run on the user's device, which sends compact feature vectors or screenshots to a cloud service hosting larger models (e.g., LPMs, LLMs, vision models). The cloud model computes action confidences and returns decisions or recommended actions, which the local device presents, filters via policies, and then executes. One device with the AI agent (for example, a phone or AR glasses) uses its camera to watch the screen of another device and control it via wireless commands (e.g., Bluetooth keyboard/mouse emulation). The AI agent recognizes UI elements using computer vision, scores possible interactions (click buttons, fill text fields, navigate menus), and triggers them when confidence exceeds thresholds, allowing automation across applications that were not explicitly instrumented. An AI agent on a controller or mobile device sends commands to machines such as robotic vacuum cleaners, drones, or vehicle subsystems. Sensors (camera, LIDAR, telemetry) define the state; the decision model outputs action commands (navigate, avoid obstacle, focus camera), with confidence used to decide between autonomous action and deferring to the user.

Disclosed here are process-level examples of “take action or not” using AI-generated confidence, independent of any specific patent claim language. In email and messaging workflows, a state may include, but is not limited to, sender, subject, prior interactions with this sender, text content, attachments, calendar context. Actions may include, but are not limited to, draft reply, auto-file to a folder, suggest attachment, forward to a colleague, summarize thread, or do nothing. A decision may include, but is not limited to, the model may output high confidence for drafting a reply to frequent senders and low confidence for unknown senders, triggering automatic drafting only in the former case; for low confidence, it may only show options.

In an example of document and data-entry processes, a state may include, but is not limited to, open spreadsheet and document windows, recognized table headers, detected entities (names, amounts, dates) in source documents. Actions may include, but are not limited to, extract data from source to sheet, validate against prior entries, generate summary or report section, flag anomalies. Decisions may include, but are not limited to, the agent auto-populates low-risk fields when confidence is high, but requires human confirmation for ambiguous mappings, driven by per-field confidence metrics.

In an example, of creative and media tasks, a state may include, but is not limited to, existing images or photos, user's past style selections, metadata (subject, context, audience). Actions include, but are not limited to, propose edits, remove objects, adjust brightness and contrast, apply artistic styles, suggest sharing the image with recognized people. Decisions include, but are not limited to, the system presents multiple edits with confidence scores; the user's selections are logged so that confidence increases for similar edits in future images and may eventually allow default auto-edits in common scenarios.

In an example, of cross-application business workflows, a state includes, but is not limited to, incoming email from an accounts receivable address, attached invoice, open accounting application, user's historical handling of similar messages. Actions include, but are not limited to, parse invoice, create draft accounting entry, route to an approver, send confirmation email, or ignore. Decisions include, but are not limited to, if confidence in correct invoice parsing and account mapping exceeds a high threshold, the system drafts the accounting entry and surfaces it for final approval; if low, it only highlights the invoice and proposed mapping for manual review.

In embodiments, to safely decide whether to act, implementations can add guardrails beyond raw confidence. Thresholds vary with action type; critical actions may require high model confidence plus explicit human approval. Special “secure steps” (e.g., password entry, financial authorization) can be tagged so that the agent pauses and prompts the user even if the model is confident.

In embodiments, “human-in-the-loop” verification can be used before implementing an action. The system can provide a final “checkpoint” screen where the user sees the impending action and approves or overrides, especially for multi-step processes spanning several applications. Eye-tracking or explicit UI interaction can be used to confirm that the user has actually reviewed critical information before the final commit. When confidence is low in a domain-sensitive decision, the agent can identify a human expert (e.g., by role or past performance) and route the task or a question to that person, treating human responses as supervision for future decisions. These patterns-state perception, model scoring, explicit confidence metrics, policy-based thresholds, and human oversight-allow AI systems, implemented in software and supported by suitable hardware, to determine in a controlled, configurable way whether to take an action within a process.

In embodiments, AI agent managers disclosed herein can decide whether to implement an action by turning “what should I do now?” into a scored decision problem, then using thresholds, rules, or learned policies to either act, abstain, or ask for help. It can also select [symbol] actions to take by mapping perceived inputs (sensor data, UI state, text, images) into a representation and using policies learned from data or rules to choose an action from a set of possibilities. A model (classifier, LPM head, etc.) can output probabilities for candidate actions; the highest probability is treated as a confidence score. A configurable confidence threshold can be set (e.g., “only send a support reply if ≥80% confidence; else escalate to a human agent”), so the AI either acts or abstains based on that threshold. In regulated or high-risk domains, multiple tiers can be used: for example, very high confidence triggers automatic action, medium confidence triggers human review, low confidence is just logged. Security and fraud systems combine anomaly scores, classification probabilities, and contextual risk factors into a composite risk score. Tiered thresholds map score ranges to actions such as “block immediately,” “flag for analyst,” “log only,” so the AI itself decides whether to actively intervene or merely observe. Response systems define a “don't know” region: if all actions are below a confidence threshold, the agent chooses a safe fallback like asking the user, routing to support, or deferring action. Some frameworks explicitly treat abstention as an action, optimized along with other outputs to balance automation and error risk. Even when a model is confident, domain rules can prevent action, such as “never auto-approve payments over $X,” forcing a human step. Conversely, rules can require action regardless of low confidence, e.g., emergency braking in autonomous vehicles when certain sensor patterns are detected.

In embodiments, selecting what action to take can be framed as a policy mapping perceptions (state) to actions. Agents can continually: (1) sense the environment through sensors or APIs, (2) compute an internal state representation, (3) decide an action, and (4) execute it. In robotics or autonomous systems, sensors (cameras, LIDAR, IMUs) feed perception modules; planning modules then choose actions like “turn left,” “brake,” “pick object,” based on the perceived state. In reinforcement learning (RL), an agent can observe a state and selects an action according to a policy that is learned to maximize expected cumulative reward. Value-based methods (e.g., Q-learning, deep Q-networks) estimate a value for each action, and the agent typically chooses the action with the highest estimated value, optionally with some exploration. Policy-based and actor-critic methods directly output a probability distribution over actions from the perceived state; the action is sampled or chosen greedily from this distribution. Research on action selection in high-dimensional spaces focuses on identifying minimal sufficient action sets to avoid unnecessary or harmful interventions while keeping performance high. Simple reflex agents map perceptual inputs directly to actions via if-then rules, such as “if obstacle detected within X meters then turn right; else move forward.” These can be enhanced with goals and utility functions that rank actions based on how well they satisfy objectives given the perceived state. Some agents maintain an internal model of how actions change the environment; they simulate future sequences of actions and choose the one that best achieves the goal, given the perceived state. Techniques like model-predictive control or search (e.g., Monte Carlo tree search in games) evaluate many candidate action sequences before deciding. In “agentic” AI, an LPM receives a structured description of the current context (tools available, user state, prior steps) and outputs proposed next actions such as API calls, UI steps, or messages. A controller layer may translate these into concrete operations, apply safety checks, and decide whether to execute them, retry, or request clarification.

Perceived inputs and their representations can be used to score and filter candidate actions. Raw inputs (text, images, audio, sensor streams) are converted into numerical representations—embeddings and feature vectors—that capture relevant structure. These vectors feed into models that output scores or distributions over actions, allowing the agent to compare alternatives quantitatively. In monitoring or control scenarios, models track learned patterns of normal behavior; deviations generate anomaly scores that gate actions like shutting down equipment or alerting operators. The magnitude and context of the anomaly score help determine if the system should automatically act or merely log and wait. Modern agents combine multiple perceived signals—user behavior, historical logs, external data sources—into a unified state to choose actions, for example, adjusting recommendations based on what the user just watched and long-term preferences. The decision logic can weigh certain inputs more heavily depending on the task or risk profile.

Within a business or technical process, these mechanisms are composed into pipelines that both choose actions and decide whether to execute them autonomously. Perceived inputs includes, but are not limited to, customer message, account history, previous tickets. Action selection can include, but is not limited to, action selection: an LLM or classifier chooses an intent (answer, escalate, ask for more info) and a candidate reply. Act-or-not logic can include, but is not limited to: if confidence in the reply exceeds a threshold and risk is low, the system sends it; otherwise it routes the ticket to a human, possibly with suggested answers attached.

In embodiments, expert input can be integrated as an additional, high-quality signal that the AI agent uses to choose and justify next actions in a process, rather than relying only on its own model confidence. In effect, the expert-network system supplies vetted human judgments (ranked and scored by credit level) that the AI action-selection system can treat as context, constraints, or direct recommendations when determining what to do next. A system can provide an AI agent manager that perceives process context (UI state, data, workflow), computes confidence scores for candidate actions, and automates or proposes actions based on thresholds and user training. Another system can provide an information-sharing manager that routes questions to human experts (candidate responders), ranks them by credit/score using response quality and timeliness, and returns expert responses to the requester. The AI agent can: detect that its own confidence is low or the action is high-risk; formulate a targeted request (with category, topic, and constraints) and send it into the expert network; and receive one or more ranked expert responses, convert them into structured recommendations, and use them as inputs to suggest or select the next process action.

In embodiments, expert input can be used for suggesting next actions. For example, the AI agent can monitor its confidence metric or other uncertainty signals while managing a process (e.g., editing a document, handling a transaction, configuring a system). If confidence falls below a threshold, or a policy indicates human oversight is required for this type of step, the AI agent manager packages the current context (task description, relevant data, category) into a request and sends it to the expert-routing system.

In embodiments, agents may be selected for suggesting next actions. For example, the information sharing manager analyzes the request, matches it to categories (e.g., “computer technology,” “finance,” “food services”), and selects candidate responders based on credit level, ranking, availability, location, or other criteria. Paths can be dynamically generated to high-credit experts; weights/pathways strengthen or weaken as experts provide timely, high-quality answers, so the AI receives responses preferentially from those with proven performance in that subject. Expert responses (which may follow templates, multiple-choice fields, or free text) are received by the AI system and parsed into structured options such as “approve request,” “request more documentation,” “apply fix X,” or “escalate to service Y.” The AI agent can combine: its own model-based action scores; the experts' recommended actions and their associated credit levels; and any user- or policy-defined preferences. The AI agent can subsequently propose a next action with a combined confidence, or directly executes if policy allows.

In embodiments, credit level and ranking can be used for AI decisions. For example, expert “credit level” and ranking (computed from correctness, usefulness, and response time) can be used as numeric weights when aggregating multiple expert suggestions. For example, if three experts recommend different actions, the AI agent can: weight each action by the recommending expert's credit level and by consistency across responders; and/or treat the aggregated expert-weighted recommendation as an external “prior” that shifts the AI's own action probabilities before deciding to act or ask the user.

In an example of integration with workflow, a user may be working in an application, and the AI agent detects an unusual error or ambiguous configuration and produces a low-confidence score for any automatic fix. The agent can send a categorized request (e.g., “computer technology/specific product/error code”) to the expert network, constrained to responders above a minimum credit level and, optionally, in a selected geographic or organizational group. One or more highly ranked experts respond with recommended steps (possibly via a structured response template). The AI can parse these into candidate actions and assigns them high prior weight because they come from high-credit experts. The AI agent manager can subsequently presents to the user: “Recommended action from certified experts: apply fix X,” along with its combined confidence metric and optionally executes that fix automatically upon user approval or under predefined policies. In this integrated design, the expert network supplies dynamically-ranked human judgments that the AI agent uses as part of its decision function, so that suggestions and next actions in a process are grounded both in learned models and in the up-to-date knowledge of vetted subject-matter experts.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A computing device comprising:
an artificial intelligence agent manager configured to:
train an artificial intelligence agent for implementing actions in a process;
determine perception of one or more objects or data within an environment;
use artificial intelligence to determine a confidence metric for a first action for interacting with the one or more objects or data within the environment based on a data model associated with the process, and/or for implementing a second action based on the data model associated with the process;
present, via a user interface, the confidence indicator or confidence metric for implementing the first action and/or the second action;
receive, via the user interface, user input that indicates whether to implement the first action and/or the second action in response to perception of the one or more objects or data within the environment during the process; and
train the artificial intelligence agent to implement the first action and/or the second action based on the user input.

2. The computing device of claim 1, wherein the one or more objects or data are one or more display objects or data displayed by a user interface.

3. The computing device of claim 1, wherein the environment comprises a displayed environment for interaction by a user.

4. The computing device of claim 1, wherein the environment comprises a real world environment perceived via a computer vision application, and wherein the one or more objects are one or more real objects or data within the real world environment, and wherein the computer vision application is configured to perceive the one or more real objects or data.

5. The computing device of claim 1, wherein the process is implemented by a computing application, and wherein the one or more objects or data are one or more display objects or data displayed on a display by control of the computing application.

6. A system comprising:
a first computing device comprising an artificial intelligence agent manager configured to:
receive contextual information that indicates a need of a first user;
process the contextual information for generative artificial intelligence response to the contextual information for providing one or more solutions to the need of the first user, wherein a result of the process is generation of an indication of confidence in the one or more solutions;
determine a second user associated with a qualification to provide a solution to the need of the first user; and
communicate to a second computing device associated with the second user some of the information for presentation to provide a solution.

7. A computing device comprising:
an artificial intelligence agent manager configured to:
receive contextual information of a first user's operation of a computing device;
determine a confidence level for sending a request including the contextual information to a second user based on the contextual information; and
receive a next action based on a received response to the request.

8. (canceled)

9. (canceled)

10. (canceled)

11. (canceled)

12. (canceled)

13. (canceled)

14. The computing device of claim 1, wherein the confidence metric is determined based on a plurality of factors, the plurality of factors comprising at least one of: an output probability from a machine learning classifier, an anomaly score relative to a learned model of normal behavior, and/or a consistency score across multiple data models.

15. The computing device of claim 1, wherein the user input comprises one of: an explicit approval of the first action, a rejection of the first action, a correction to the first action, or a selection of an alternative action from a plurality of proposed actions presented via the user interface.

16. The computing device of claim 1, wherein the artificial intelligence agent manager is further configured to automatically implement the first action without receiving the user input if the determined confidence metric exceeds a predefined high-confidence threshold, and to prevent implementation of the first action if the confidence metric is below a predefined low-confidence threshold.

17. The computing device of claim 16, wherein the predefined high-confidence threshold is dynamically adjusted based on a classification of the first action, and
wherein a higher threshold is applied for actions classified as high-risk including financial transactions or system configuration changes.

18. The computing device of claim 1, wherein the artificial intelligence agent manager configured to use the user interface to display a visual indicator on the user interface, the visual indicator being one of: a numerical percentage, a color-coded alert, or a graphical gauge representing the level of confidence.

19. The computing device of claim 1, wherein the process involves a workflow spanning multiple software applications, and wherein the artificial intelligence agent is trained to perceive objects and data across the multiple software applications to maintain context for implementing the first action and the second action.

20. The computing device of claim 4, wherein the computer vision application is integrated into a wearable device, and wherein the environment comprises the real-world environment as perceived through the wearable device.

21. The computing device of claim 20, wherein the wearable device comprises augmented reality glasses, and wherein presenting the confidence metric comprises overlaying the confidence metric as a visual element onto the user's view of the real-world environment.

22. The computing device of claim 4, wherein the first action comprises controlling a robotic actuator to physically interact with one of the one or more real objects based on the user input.

23. The computing device of claim 4, wherein the perception of the one or more real objects or data is achieved through analysis of a real-time video stream, and wherein the confidence metric is further based on the consistency of the perception over a plurality of video frames.

24. The system of claim 6, wherein the qualification of the second user is determined based on a credit level, the credit level being calculated from a history of the second user's performance in providing solutions, the history comprising metrics for at least one of: correctness, usefulness, or response time.

25. The system of claim 24, wherein the artificial intelligence agent manager is further configured to update the credit level of the second user based on an evaluation of the solution provided in response to the communication.

26. The system of claim 6, wherein the contextual information comprises a specific domain of knowledge, and wherein the second user is determined from a pool of users based on a matching of the specific domain of knowledge with the second user's declared expertise and historical performance.
